(19) United States
(12) Patent Application Publication
(10) Pub. No.: US 2002/0170058 A1
(43) Pub. Date: Nov. 14, 2002

(54) Method of visually processing image files and an image editor using the same

(76) Inventor: Cheng-Chia Chang, Tainan (TW)

Correspondence Address: BIRCH STEWART KOLASCH & BIRCH, PO BOX 747, FALLS CHURCH, VA, 22040-0747, US

(21) Appl. No.: 10/139,400

(22) Filed: May 7, 2002

(30) Foreign Application Priority Data
May 9, 2001 (TW) 90111009

(51) Int. Cl. H04N 5/445

(52) U.S. Cl. 725/41; 725/37

(57) ABSTRACT

A method of visually processing image files in an image editor and an image editor using the same. A plurality of thumbnails of the image files are produced from the content of the image files. These thumbnails are drawn on a file list of the image editor. The file list shows the filenames and the accompanying thumbnails of the image files and the user can make file selections based the visual information. During operation, the image editor continuously detects whether the user has performed the compilation of the image files. When the image files have been edited, the thumbnails displayed on the file list are dynamically updated according to the content of the image files.

### BACKGROUND OF THE INVENTION

1. Field of the Invention

The present invention relates to a file management technique, more specifically, to an image editor for visually processing image files or video files to aid the user. In the following description, the term “image” is directed to a still image or a set of video data containing successive frames.

2. Description of the Prior Art

In virtue of development of digital technology, many photographs and films can be digitized and stored as image files, which are convenient for storage and suitable for additional editing or retouching processes. In fact, users use the image editor to load these image files and to provide several image processing functions, such as the addition of special visual effects and the correction of the images, to edit these image files.

FIG. 1 (Prior Art) displays a schematic diagram of a display window of the conventional image editor. During practical operations, the user can simultaneously open or create a plurality of image files in the workspace of the image editor. In FIG. 1, numeral 1 represents a display window of the image editor, numeral 10 represents a workspace on which all opened files are displayed, and numeral 12 represents a menu bar including various user commands. On the workspace 10 shown in FIG. 1, there exist a plurality of opened or newly created image files, which are opened by the user. Each of these image files is allocated to a corresponding window interface, which can be a visible and active window (such as window 100), a partially visible but inactive window (such as windows 110 and 111), or a minimized window (such as windows 120, 121, 122 and 123). In the case shown in FIG. 1, the total number of all opened files exceeds the number of the identified windows. A list of all opened files can be found in the opened file list 130 in the command “Window” of the menu bar 12. The command “more Windows . . . ” shown in the opened file list 130 is used to display the rest of the opened files.

When a user works and selects a file or window on the interface shown in FIG. 1, the user usually opens the pop-up menu of the opened file list 130 through the image editor 1, as displayed in FIG. 1, and selects a desired image file according to its filename. However, such scheme is not convenient to the user since it is difficult to associate with the image contents of these image files in considering their filenames for the user. Especially, the image editor usually names newly created image files by a common filename pattern, such as “Untitled #n”, where n means a number. However, the user can rarely make any selection according to such filenames.

An approach to solving the above problem is to partially tilt all of the windows or opened image files on a screen, like the windows 110 and 111 shown in FIG. 1. However, since the user only can view a small piece of each image file, it is still difficult to remember the correct content of the image file. In the most cases, the user must browse each of the image files to get the desired image file.

In addition, according to the above description, if the user opens or creates too many image files at the same time when operating the image editor, the selection of the desired image files becomes more difficult.

Some conventional image browsers provide thumbnails of the image files to assist the user in making the selection among a large number of pictures. However, the conventional scheme cannot be directly applied to the applications of the image editors to provide the visual selection of the image files. The reason is that the image files in the image editor can be edited or modified. Therefore, if the user is editing an image file, the thumbnail of the image file will be changed. The conventional image browser can only process the existing image data and cannot provide the editing function.

### SUMMARY OF THE INVENTION

Therefore, the object of the present invention is to provide a method for visually processing the image files and an image editor using the same

The present invention achieves the above-indicated objects by providing a method of visually processing image files in an image editor. At first, a plurality of file handles corresponding to the image files opened in the image editor are captured. Based on the file handles, the thumbnails of the image files are generated from the contents of the image files. These thumbnails are then displayed on a file list of the image editor to illustrate the opened image files. The file list can be the opened file list of a menu bar of the image editor or an independent window activated by the image editor. As the user activates the file list, the thumbnails and the filenames of the image files are shown to assist the user to select the desired image file. During operation, the image editor can detect whether the user makes the compilation of the image files. When the image files have been edited, the thumbnails displayed on the file list are dynamically updated according to the contents of the image files. In the present invention, the method of visually processing the image files is to create an image file list having a plurality of thumbnails corresponding to the contents of the image files and to dynamically update the thumbnails of the image file list according to the compilation of the image files.

In addition, the present invention also provides an image editor with a visual processing function. The image editor comprises a capturing unit for capturing a plurality of file handles corresponding to opened image files, a generating unit for generating thumbnails of the opened image files from the content of the opened image files based on the file handles, a display unit for displaying the thumbnails on a file list to illustrate the opened image files, and an update unit for detecting the compilation of the opened image files and dynamically updating the thumbnails displayed on the file list according to the content of the opened image files when the compilation of the image files occurs.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 (Prior Art) is a schematic diagram illustrating a display window of the conventional image editor;

FIG. 2 is a schematic diagram illustrating a user interface designed for a first scheme of visually processing opened image files according to the embodiment of the present invention;

FIG. 3 is a schematic diagram illustrating a user interface designed for a second scheme of visually processing opened image files according to the embodiment of the present invention;

FIG. 4 is a schematic diagram illustrating another user interface designed for the second scheme of visually processing opened image files according to the embodiment of the present invention;

FIG. 5 is a block diagram of the image editor with the visual processing function according to the embodiments of the present invention;

FIG. 6 is a flowchart of the operating steps of the capturing unit, generating unit and the display unit according to the embodiment of the present invention;

FIG. 7 is a flowchart of the operating steps performed in the update unit according to the embodiment of the present invention; and

FIG. 8 is a flowchart of the operating steps performed in the operating unit according to the embodiment of the present invention.

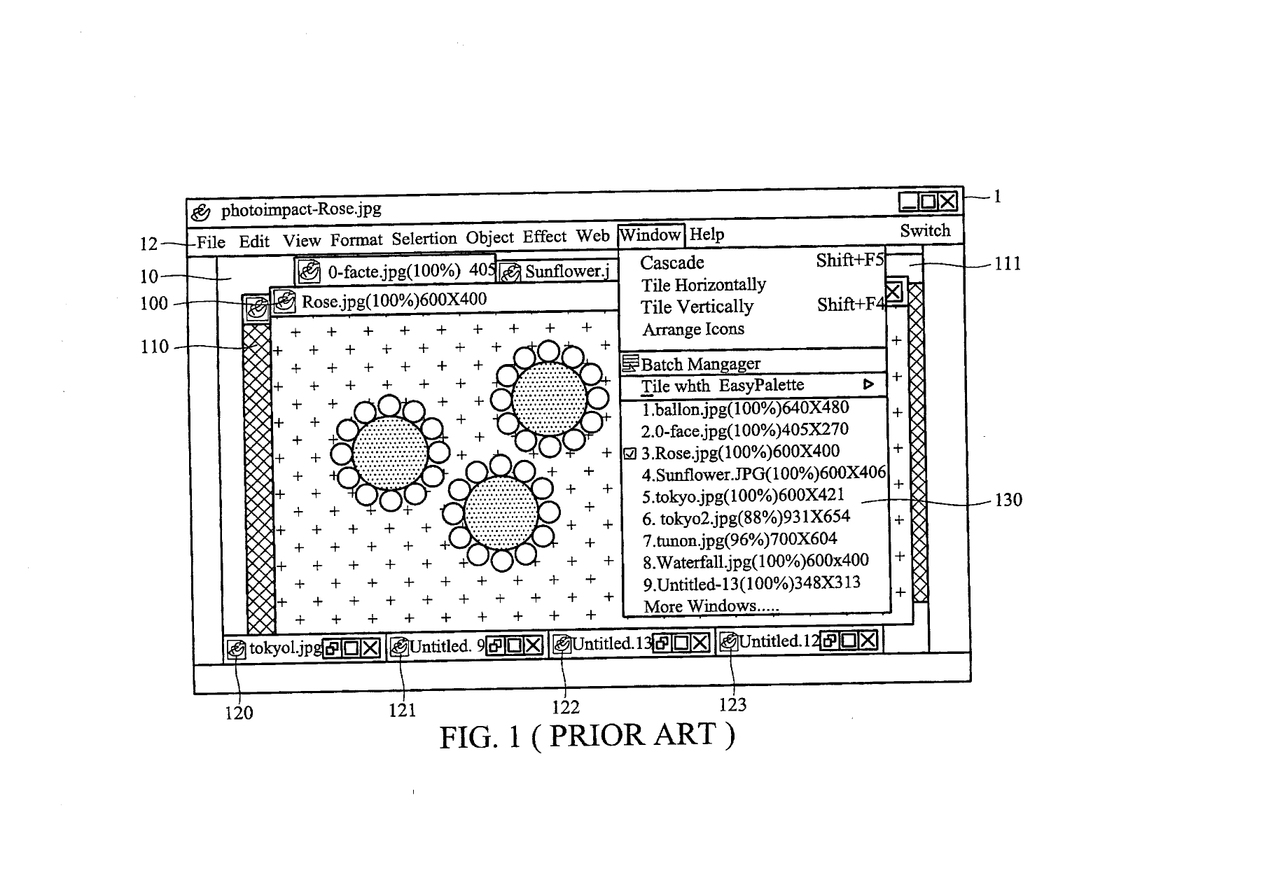

### DETAILED DESCRIPTION OF THE INVENTION

The present invention discloses a method of visually processing image files in an image editor, in which the user can discover the contents of the image files based on the file list without viewing the true contents of the image files. This method disclosed below can also he incorporated in an image editor to provide a visual interface of the file management and to facilitate the operation of the user. In view of the accompanying drawings, the embodiment of the present invention is described as follows.

In the method of visually processing image files in the present invention, two schemes are proposed to provide information such that the user can remember the contents of the image files without direct viewing. The first scheme is to use the opened file list of the menu bar provided by common image editors and the second scheme is to use an independent window to display the information.

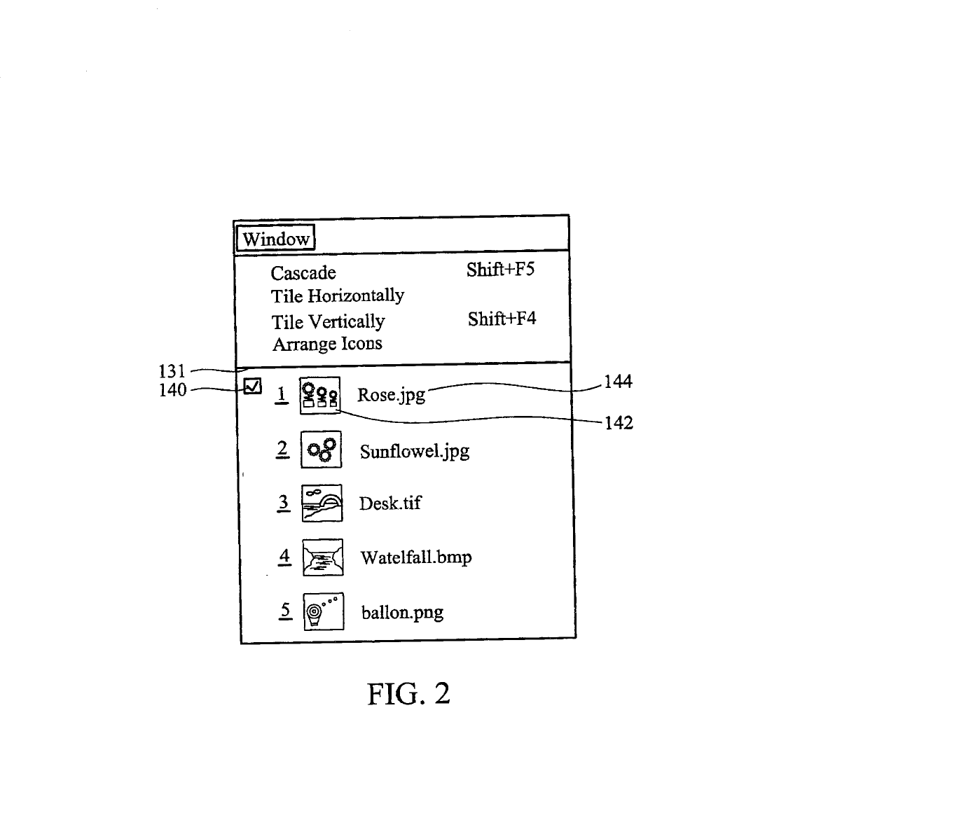

FIG. 2 is a schematic diagram illustrating a user interface designed for the first scheme of visually processing opened image files in the present invention. As shown in FIG. 2, in the opened file list of the menu bar, each filename is appended to a thumbnail, which is a contraction of the contents of the corresponding image file. When the user clicks the command “Window” of the menu bar, a pop-up opened file list 131 is displayed. Each item of the opened file list 131 includes a filename 144 and a thumbnail 142 of the corresponding opened image file. In addition, in the case of FIG. 2, the checkup symbol 140 appeared on the left of the filename “Rose.jpg” means this image file has been selected. Using the user interface shown in FIG. 2, the user can properly select the desired images in view of their thumbnails without merely relying on their filenames.

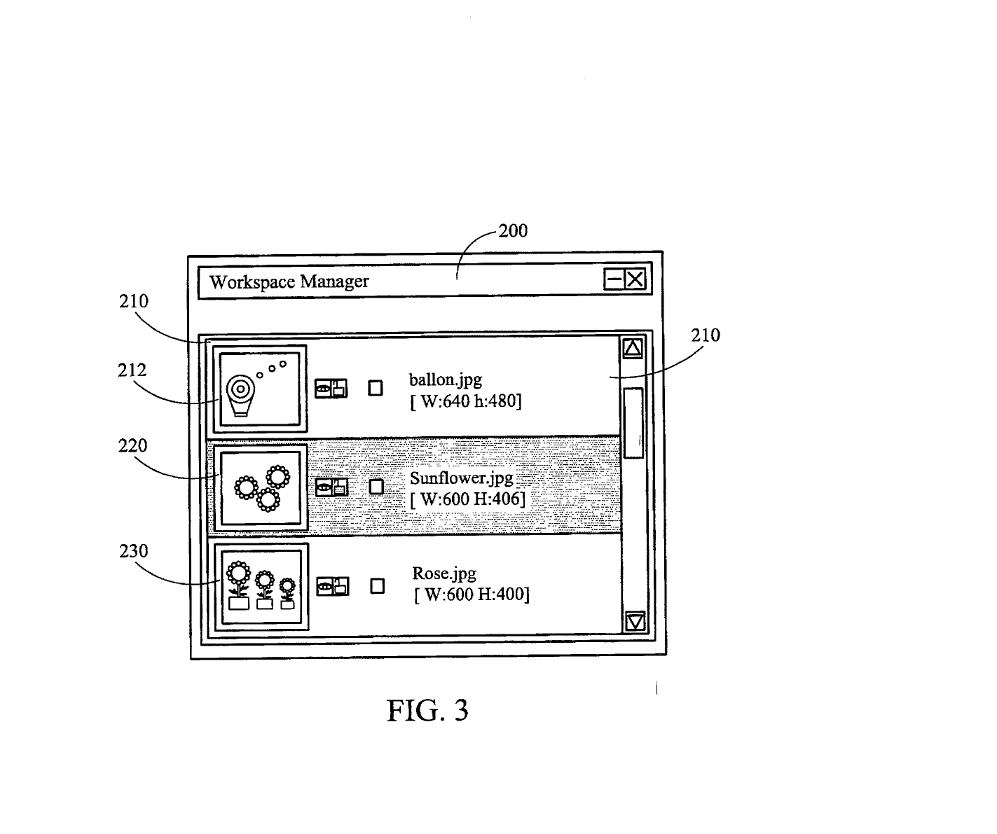

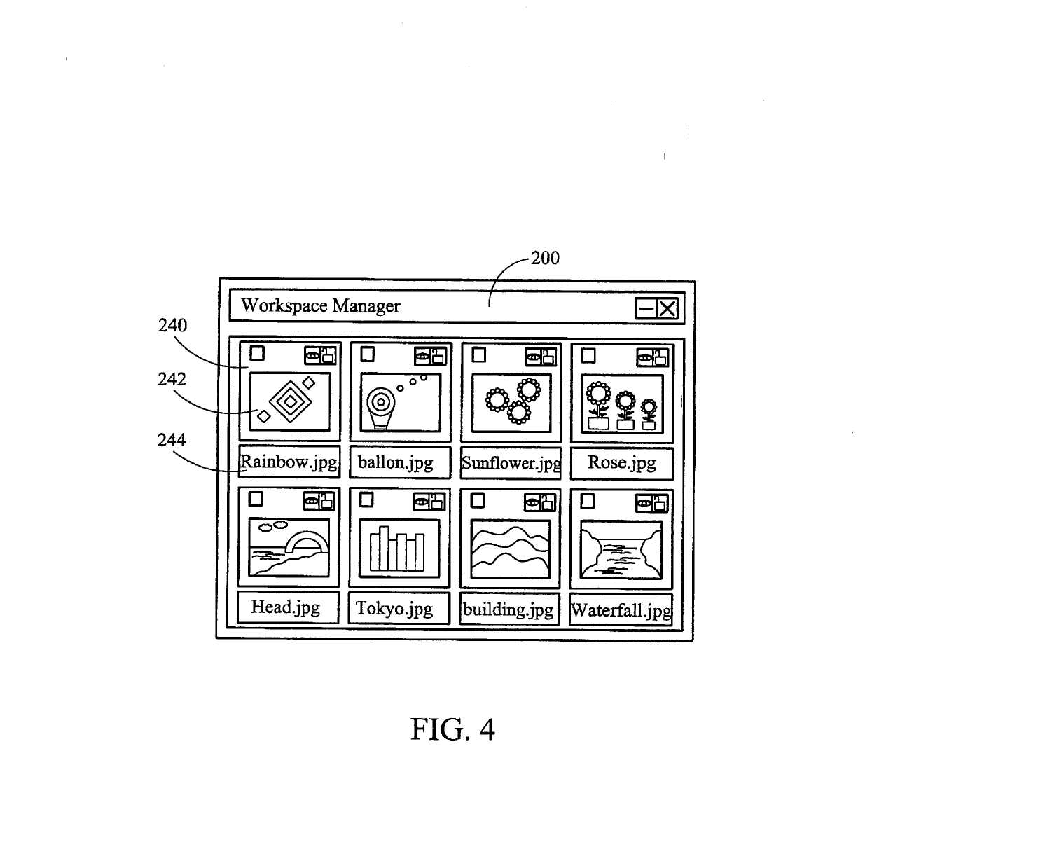

FIG. 3 is a schematic diagram illustrating a user interface designed for the second scheme of visually processing opened image files in the present invention, in which the thumbnails of the image files are displayed in an independent window. In FIG. 3, numeral 200 represents the independent window that is activated at the command of the image editor. In the independent window 200 there are three file items 210, 220 and 230, each of which includes a thumbnail 212 and file attribute information 214. Similarly, using the user interface shown in FIG. 3, the user can also directly view the thumbnails and the attribute information of the image files and select the desired image files to be edited or processed, without merely relying on their filenames. FIG. 4 is a schematic diagram illustrating another user interface designed for the second scheme. In FIG. 4, each file item 240 only displays its filename and its thumbnail, which can make the independent window display more image files at the same time. In addition, the user can still select the desired image files in view of their thumbnails.

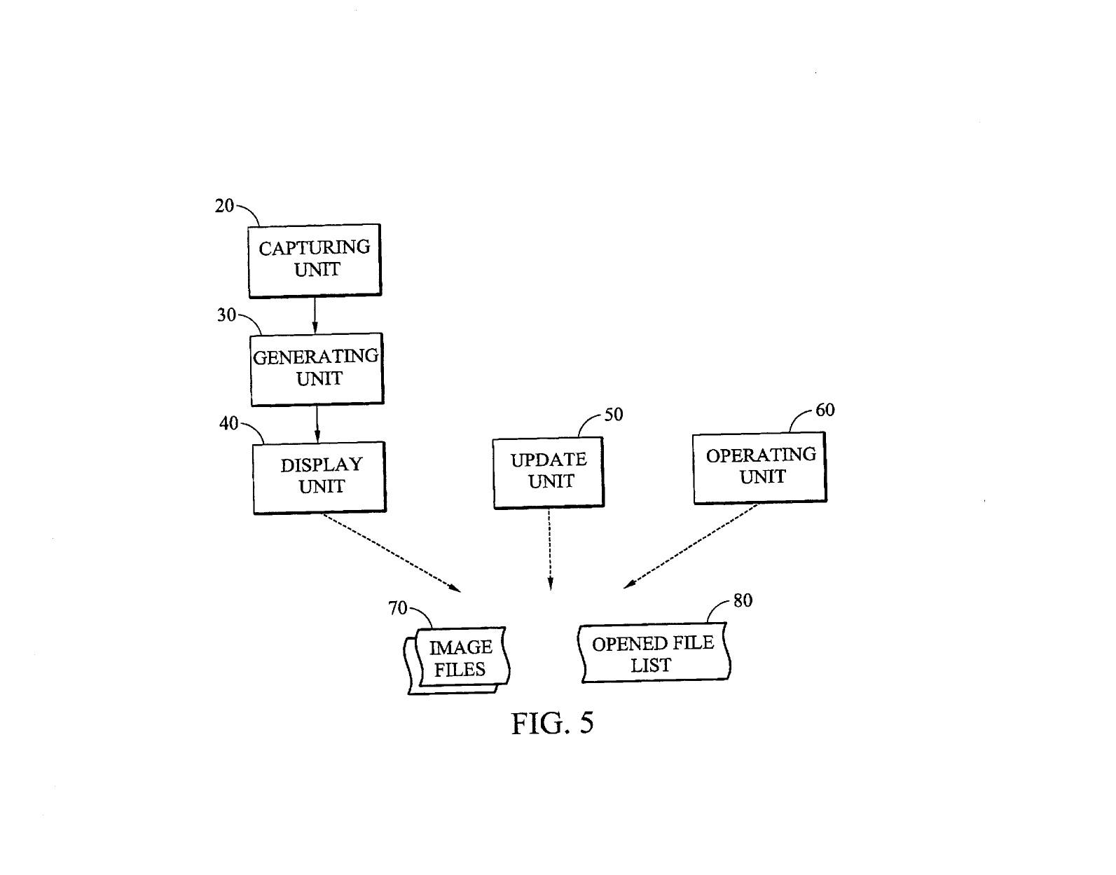

FIG. 5 is a block diagram of the image editor with the visual processing function according to the embodiments of the present invention. The image editor includes a capturing unit 20, a generating unit 30, a display unit 40, an update unit 50 and an operating unit 60, which are used to process the image files 70 opened by the image editor and to create an opened file list 80 with the visual processing function. It is noted that the original functional modules of the image editor are not displayed for clarity.

The capturing unit 20 is used to capture window or file handles of the image files 70 that have been opened in the image editor. The generating unit 30 is used to generate thumbnails of the opened image files 70 according to their window or file handles. The display unit 40 is used to display the thumbnails of the opened image files 70 in the opened file list 80 provided by the image editor to illustrate the contents of the opened image files 70, such as the situations shown in FIG. 2, FIG. 3 and FIG. 4. Thus, the opened file list 80 can show the contractions of the contents of the opened image files by means of the capturing unit 20, the generating unit 30 and the display unit 40.

In addition, the update unit 50, following the compilation of the image data by the user, updates the thumbnails displayed in the opened file list 80. The update unit 50 can continuously detect if any opened image files 70 have been changed and dynamically update the thumbnails of the opened image files 80 according to the changed image contents of the opened image files 80. In addition, the operating unit 60 executes a concurrent operation on more than one opened image files for the same manipulation. For example, the user can execute a command “SAVE and CLOSE” over several image files. At this time, the operating unit 60 can perform the concurrent operation until the user selects the desired image files and inputs the corresponding command.

The operating steps of the processing units in the image editor of the present invention will be described as follows.

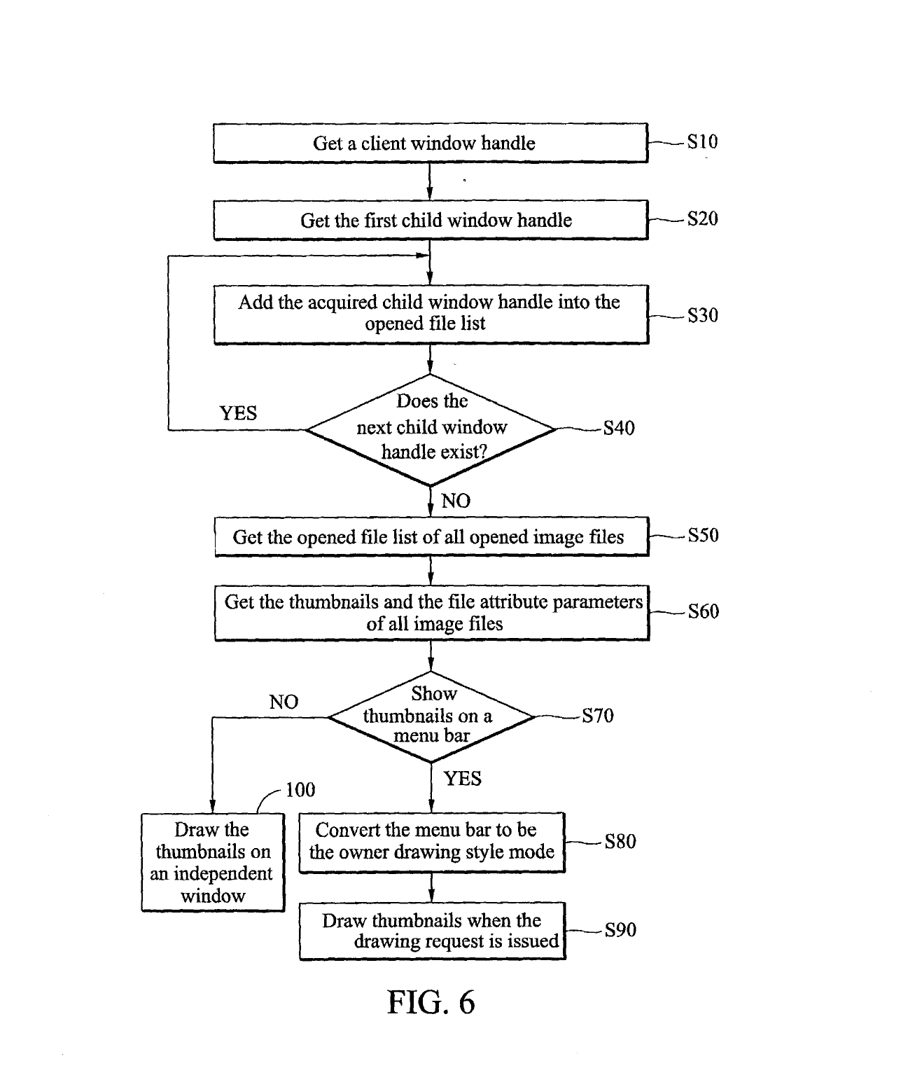

FIG. 6 is a flowchart of the operating steps of the capturing unit 20, the generating unit 30 and the display unit 40 according to the embodiment of the present invention. In FIG. 6, steps S10 to S50 are executed by the capturing unit 20. Step S60 is executed by the generating unit 30. Steps S70 to S100 are executed by the display unit 40.

At first, the capturing unit 20 gets a client window handle of the image editor (step S10). Next, the capturing unit 20 further gets a first child window handle according to the client window handle (step S20), which corresponds to one opened image file in the image editor. Then the acquired child window handle is added to the opened file list 80 (step S30). The capturing unit 20 recursively verifies if a next child window handle exists or not (step S40). If one exists, the corresponding child window handle of the next child window handle is added to the opened file list 80 (step S30). If not, the search for the child window handles is completed. At this time, the capturing unit 20 gets the opened file list 80 of all opened image files (step S50).

Next, the generating unit 30 sequentially generates the thumbnails and the file attribute parameters of all image files according to the acquired opened file list 80 (step S60). In the preferred embodiment, the thumbnail can be a contraction of the original image with a reduced scale for still image data or a contraction of the first image frame with a reduced scale for video data. The file attribute parameters can be the filename of the image file, the file size, the image format, and so on.

Finally, the display unit 40 determines that the generated thumbnails need to be displayed on a menu bar like the case shown in FIG. 2 or on an independent window like the cases shown in FIG. 3 and FIG. 4 (step S70). If the thumbnails of the image files 70 are ready to be displayed on the menu bar, the display unit 40 will convert the menu bar to the user drawing style mode (step S80), allowing customization of the menu by the user. When the user clicks the menu bar to illustrate the opened file list 80, the system can issue a drawing request for drawing the thumbnails of the image files on the opened file list of the menu bar (step S90). On the other hand, if the thumbnails of the image files are ready to be displayed on an independent window, the display unit 50 will render the thumbnails in the independent window as the user inputs the corresponding command (step S100).

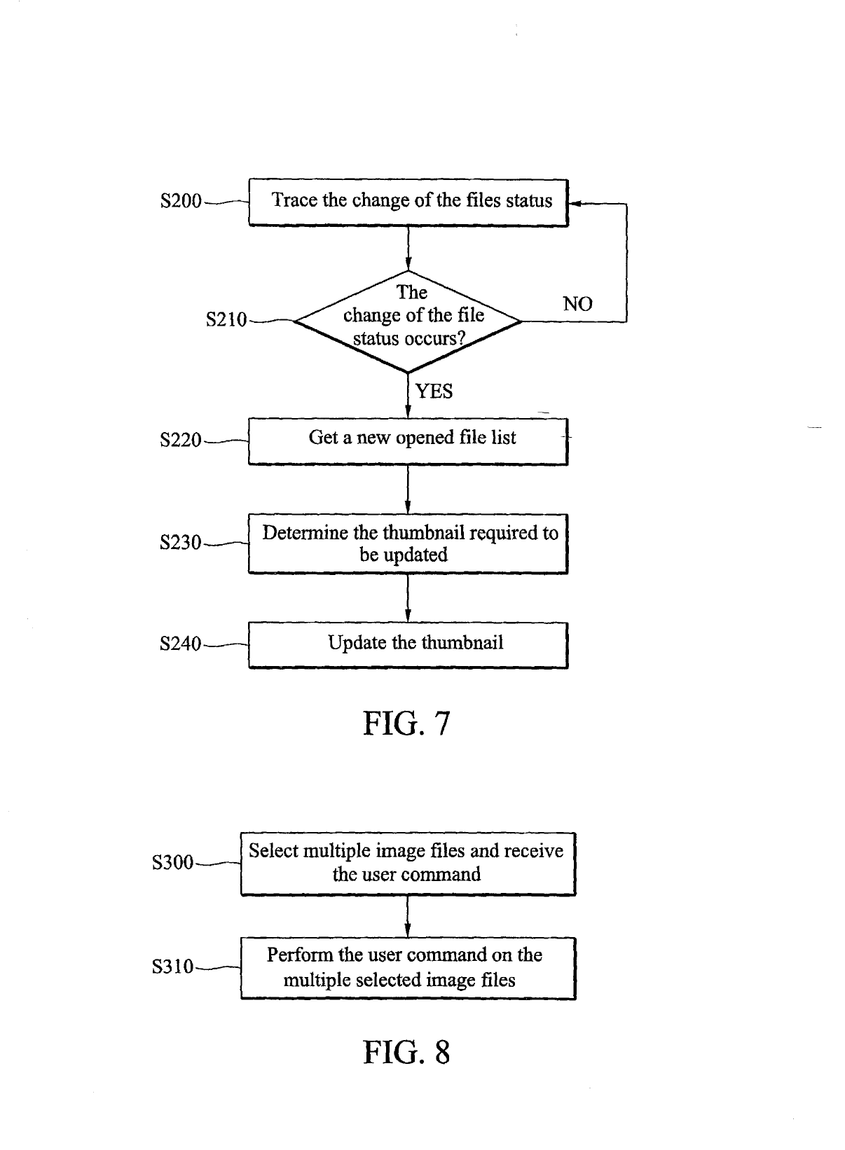

FIG. 7 is a flowchart of the operating steps performed in the update unit 50 according to the embodiment of the present invention. When the user is operating the image editor, the system can detect all of the operations performed by the user. The update unit 50 is able to trace the change of the image file status (step S200), such as creating a new image file by user, closing an opened image file or editing an existing image file. When the change of the image file status occurs (step S210), the update unit 50 needs to get a new opened file list using the capturing unit 20 (step S220). Then the update unit 50 compares the new version and the old version of the opened file list 80 and determines if the thumbnail required has been updated (step S230). Finally, the generating unit 30 is activated to reproduce the thumbnail to be updated (step S240). When the user uses the menu bar or the independent window to locate the desired image file, the display unit can display the updated thumbnail.

FIG. 8 is a flowchart of the operating steps performed in the operating unit 60 according to the embodiment of the present invention. As described above, in the preferred embodiment of the present invention, the user can assess the content of the image files by viewing the thumbnails shown on the menu bar or the independent window. The operating unit 60 in the preferred embodiment is used to handle a plurality of image files according to the same user command at the same time. The user can choose one or more image files to be processed at the same time in the independent window, like that shown in FIG. 3, which displays the filenames and thumbnails of the image files. In addition, the operating unit 60 also receives a user command to deal with the chosen image files (step 300). The operating unit 60 can perform the user command on the chosen image files, which can speed up and facilitate the user operation.

As described above, the objective of the present invention is to facilitate the user operation. In the above preferred embodiment, the thumbnails of the image files are applied to the opened file list of the image editor and the user can assess the content of these image files and make selections according to the appended thumbnails, which can achieve the function of visually processing the image files in the image editor.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of visually processing image files in an image editor, comprising the steps of:
capturing a plurality of file handles corresponding to the image files opened in the image editor;
generating thumbnails of the image tiles from the content of the image files based on the file handles;
displaying the thumbnails on a file list of the image editor to display the opened image files;
detecting whether the content of the image files is updated; and
dynamically updating the thumbnails displayed on the file list according to the content of the image files when the content of the image files are updated.

2. A method as recited in claim 1, wherein the image files are still images.

3. A method as recited in claim 1, wherein the image files are video data and in the generating step the thumbnails are generated by first frames of the video data.

4. A method as recited in claim 1, wherein in the display step the thumbnails are displayed on the file list of a menu bar of the image editor.

5. A method as recited in claim 1, wherein in the display step the thumbnails are displayed on the file list of an independent window activated by the image editor.

6. A method as recited in claim 5, further comprising the steps of:
Selecting a plurality of second image files from the file list of the independent window;
Receiving a user command to concurrently process the second image files; and
Executing the user command on the selected second image files.

7. A method of visually processing image files in an image editor, comprising the steps of:
creating an image file list having a plurality of thumbnails corresponding to the content of the image files; and
dynamically updating the thumbnails of the image file list according to the compilation of the image files in the image editor.

8. A method as recited in claim 7, wherein the image files are still images.

9. A method as recited in claim 7, wherein the image files are video data.

10. An image editor with a visual processing function, comprising:
a capturing unit for capturing a plurality of file handles corresponding to opened image files;
a generating unit for generating thumbnails of the opened image files from the content of the opened image files based on the file handles;
a display unit for displaying the thumbnails on a file list to display the opened image files; and
an update unit for detecting the compilation of the opened image files and dynamically updating the thumbnails displayed on the file list according to the content of the opened image files when the compilation of the image files occurs.

11. An image editor as recited in claim 10, wherein the image files are still images.

12. An image editor as recited in claim 10, wherein the image files are video data and the generating unit generates the thumbnails using first frames of the video data.

13. An image editor as recited in claim 10, wherein the thumbnails are displayed on the file list of a menu bar of the image editor.

14. An image editor as recited in claim 10, wherein the thumbnails are displayed on the file list of an independent window activated by the image editor.

15. An image editor as recited in claim 14, further comprising:
an operating unit for selecting a plurality of second image files from the file list of the independent window, receiving a user command for concurrently processing the second image files and executing the user command on the selected second image files.
